(19) United States
(12) Patent Application Publication
(10) Pub. No.: US 2018/0117549 A1
(43) Pub. Date: May 3, 2018

(54) DISPENSING MACHINE, IN PARTICULAR FOR PRODUCING PAINT SAMPLES

(71) Applicant: ALFA S.R.L., Bologna (IT)

(72) Inventors: Edoardo ROSSETTI, Bologna (BO) (IT); Marco ROSSETTI, Bologna (BO) (IT)

(21) Appl. No.: 15/562,208

(22) PCT Filed: Apr. 18, 2016
(86) PCT No.: PCT/IB2016/052195

§ 371 Date: Sep. 27, 2017

(30) Foreign Application Priority Data
Apr. 17, 2015 (IT) BO2015A000193
Apr. 17, 2015 (IT) BO2015A000194
Apr. 17, 2015 (IT) BO2015A000195
Apr. 17, 2015 (IT) BO2015A000196
Apr. 17, 2015 (IT) BO2015A000197
Apr. 17, 2015 (IT) BO2015A000198

(51) Int. Cl. B01F 13/10; B05C 5/02; B05C 13/02; B05C 9/12; B65B 3/12

(52) U.S. Cl. CPC B01F 13/1055; B05C 5/0208; B05C 13/02; B01F 2215/005; B01F 13/1072; B65B 3/12; B05C 9/12

(57) ABSTRACT

A dispensing machine for producing paint samples including a main delivery unit for delivering at least two main paints via at least two main pumps, and a colourant delivery unit for delivering a plurality of colourants via a corresponding plurality of colourant pumps. The main pumps are volumetric pumps each having a first swept volume. The colourant pumps are volumetric pumps each having a second swept volume, less than the first swept volume. The machine additionally includes at least one magazine for empty containers. The machine can include at least one magazine for container cover elements. A handling system conveys a container from the container magazine to a common delivery zone and from there to a capping station.

### FIELD OF THE INVENTION

The present invention relates to the sector of dispensing fluid products such as paints, colourants and the like. The invention has been developed particularly in relation to a dispensing machine used for delivering paint samples, also known as colour testers.

### TECHNOLOGICAL BACKGROUND

In the sector of retail paint sales, for example in interior use, it is common practice to provide paint samples in small containers of, for example 50, 100 or 200 mL. These paint samples are inexpensive and therefore allow a user to purchase a number of different shades for testing in the place of use, so as to assess their effect and thus choose the preferred shade, for purchase or ordering in a larger quantity. Paint samples are therefore provided in sales points for each shade or colour tone.

Colourant dispensing machines comprise a plurality of tanks containing fluid colourants. To obtain paint of a particular colour, a dispensing machine delivers a predetermined quantity of the various colourants, which are added and mixed into a base paint contained in a pot. The colourants are delivered by actuating one or more volumetric pumps that take desired quantities of colourant from the respective tanks and transfer them to a delivery nozzle below which the pot with the base paint is placed.

The delivery of fluid colourant products raises some problems that are unknown in other sectors where volumetric pumps are used, such as for delivering drinks or for injecting plastics. In fact, fluid colourant products have particular physicochemical properties that require special expedients. Many colourants are aggressive and corrosive, and therefore the pumps must be wear-resistant. Fluid colourant products are also somewhat viscous, and tend to absorb air within them, which has to be expelled before the actual delivery starts, so as not to compromise the accuracy and repeatability of the delivery.

Various types of volumetric pumps are used in the sector of colourant dispensing machines. WO 1986/02320 shows a known type of dispensing machine. This type of dispensing machine usually has gear-type volumetric pumps. Gear-type pumps make it possible to achieve high dispensing volumes and are typically used for industrial-type plants. This type of pump is particularly susceptible to wear, especially where the fluid colourant products contain granular particles, such as poorly micronised fillers or in the case of metallic paints for vehicle bodywork.

U.S. Pat. No. 5,511,695 discloses a dispensing machine with piston-type volumetric pumps. This type of pump is somewhat bulky, and also has problems of wear and sealing at the sliding seals.

WO 2000/46506 discloses an injection pump for a dispensing machine, comprising a variable-volume pumping chamber defined by bellows. The bellows lengthen and shorten under the pressure of a stepping motor. The lengthening of the bellows causes the fluid product to be sucked into the pumping chamber through a non-return suction valve, while the shortening of the bellows drives the fluid product towards the delivery conduit through a second, non-return delivery valve. In this type of pump, the implementation of the bellows is critical for ensuring reliability and repeatability, and for this reason the pump is particularly expensive. Furthermore, the colourant tends to remain in the folds of the bellows, settling and, over time, reducing the performance and accuracy of the pump.

WO 2008/105007 shows a pumping unit for a colourant dispensing machine. In this case the colourant is delivered by means of a single-screw pump, with a helical rotor and a rubber stator. This pump has a limited rate of flow and cannot be actuated at excessive speeds because it gets hot and tends to seize up.

EP 2174009 discloses another type of volumetric pump for a colourant dispensing machine. In this case, a piston moves alternately within a sleeve so as to define a variable cylindrical volume. An elongate bellows-shaped element is positioned behind the piston, and has the function of sealing and guiding the sleeve. In this pump the colourant tends to retain air inside it; since the air is compressible, the accuracy and repeatability of colourant delivery by this pump are unsatisfactory. Furthermore, in this pump the colourant tends to settle on the head.

US 2005/092386 describes a dispensing machine that combines volumetric and gravimetric delivery. Colourant tanks with a small volume are mounted on board the dispensing machine, connected to respective colourant pumps. Larger, external tanks, connected to respective pumps outside the dispensing machine, effect the supply of base materials to delivery nozzles positioned around the centre of the nozzles for the colourants.

WO 99/34905 describes a dispensing machine for colourants and bases that can be mounted on board a pumping machine with various features, for delivering bases and colourants with various rates of flow. This machine is very bulky because it is designed to deliver very large quantities of finished paints into large containers.

### SUMMARY OF THE INVENTION

One objective of the present invention is to provide a dispensing machine that can deliver paint samples automatically when a shade is selected by a user. Another objective of the present invention is to provide a dispensing machine that requires no intervention by an operator in normal operation. Another objective of the invention is to produce a compact dispensing machine that occupies relatively little space, so that it can conveniently be used even in retail business establishments of limited size or where the sales areas have high occupancy costs. Another objective of the invention is to produce a dispensing machine that causes as little soiling as possible. Another objective of the invention is to produce a dispensing machine with an automatic distributor of empty containers and a system for capping said containers after delivery of each paint sample. Another objective of the invention is to produce a dispensing machine that is reliable, and that automatically recognises error situations or malfunctions. Another objective of the invention is to produce a dispensing machine that does not require immediate action to top up the tanks of main product or colourant. Another objective is to produce a machine that is safe and accurate, with relatively fast delivery. Another objective is to produce a completely automatic paint sample dispensing machine. Another objective is to produce an inexpensive dispensing machine that performs better than known types of machine. Another objective is to produce a machine that is simple from the point of view of automation, both as a whole and in relation to its individual components. Another objective is to produce a dispensing machine that can deliver quantities of products nearly continuously or, conversely, with a time lag, without thereby impairing the quality of delivery. Another objective of the invention is to produce a volumetric pump and a pumping unit that resolve the problems of the prior art, and in particular provide high accuracy and repeatability when dispensing fluid products such as paints, colourants and the like. Another objective of the invention is to provide a volumetric pump and a pumping unit that are economical and reliable, and can guarantee a long service life with the nominal characteristics. Another objective of the invention is to provide a volumetric pump and a pumping unit that are compact and easy to fit and maintain on a dispensing machine. Another objective of the invention is to provide a pump and a pumping unit that can deliver accurately and repeatably even very small quantities of fluid product, to allow high accuracy in reproducing a wide range of colour gradations in the finished paints. Another objective of the invention is to provide a pump and a pumping unit that can easily be assembled in different configurations for the volume and principle used, so that they are versatile according to the specific characteristics of the fluid to be handled. Another objective of the invention is to produce a machine with an extremely low, or no, risk of the products to be delivered drying out in the delivery nozzles or conduits.

To achieve the objectives mentioned above, a description is given of a dispensing machine and its various components, and also one for delivering fluid products, and a method for producing paint samples.

According to a first aspect, a dispensing machine for producing paint samples comprises a main delivery unit. The main delivery unit comprises main pumps. The main delivery unit is intended for the delivery of at least two main paints by means of at least two respective main pumps. The dispensing machine comprises a colourant delivery unit for delivering a plurality of colourants by means of a corresponding plurality of colourant pumps.

According to a particular aspect, the dispensing machine comprises at least one container magazine. The dispensing machine comprises a container handling system. The container handling system comprises a member for supporting one container. The container handling system can move at least from the container magazine to a delivery zone. The delivery zone is common to the main delivery unit and the colourant delivery unit. The handling system allows an empty container to be conveyed from the container magazine to the delivery zone. Both the main delivery unit and the colourant delivery unit are contained completely inside the dispensing machine. The container magazine is also advantageously contained inside the dispensing machine. The containers in the container magazine are stored empty, and are conveyed automatically one by one as required by the handling system to the delivery zone, for filling. The containers are advantageously small in size, suitable for preparing paint samples. The containers in the container magazine can advantageously be stacked to reduce the space occupied by the dispensing machine. One of the main advantages of the dispensing machine described is that it is compact and therefore requires little space in the business establishments in which it is used. This is an advantage which is particularly valuable in the case of small business establishments, or ones that are already full of machinery and/or goods, or where space in the business establishments is expensive, with a high occupancy value, as in the aisles of department stores and in major retail business establishments. The possibility of producing paint samples in a limited space also makes it possible to eliminate the extensive shelving which is normally intended for storing factory-made paint samples and displaying them to the public.

According to another particular aspect, the container magazine comprises supports for truncated-cone-shaped containers stacked inside one another. In this way the containers can be stacked and easily extracted from one another. According to another particular aspect, a container extraction device is provided for extracting one empty container at a time from the container magazine and transferring it to the support member of the handling system.

According to a particular aspect, the main pumps are volumetric pumps each having a first swept volume, and the colourant pumps are volumetric pumps each having a second swept volume, less than the first swept volume. The two different swept volumes make it possible to quickly deliver large quantities of the main products and at the same time modest amounts of colourants with greater accuracy and resolution.

According to a particular aspect, the main pumps and the colourant pumps deliver fluid products through respective main delivery conduits and colourant delivery conduits. The delivery conduits, both main and for colourants, all emerge into a delivery zone positioned within the dispensing machine. This makes it possible to dispense any type of product into the same container placed in the delivery zone, without the need to move the container in order to complete delivery.

According to another particular aspect, the main delivery unit comprises main paint tanks positioned below the colourant delivery unit. This makes it possible to produce a very compact machine. In particular, since the main paints can be delivered by pumps with a greater swept volume than that of the colourant pumps, it is possible to design delivery conduits for the main paint tanks that are also longer than those coming from the colourant tanks, which might suffer more from losses of load. Furthermore, since the main paint tanks are positioned at the bottom, they can be easily extracted from the dispensing machine and easily topped up despite their relatively large dimensions. Since the colourant tanks are smaller they can easily be filled even if they are raised above the ground. To facilitate this topping-up manoeuvre, and to simplify the production of the dispensing machine, according to another particular aspect the colourant delivery unit is supported by a support plate placed substantially at an intermediate height relative to the total height of the dispensing machine. The arrangement of said support plate advantageously allows the aforementioned container magazine to be supported.

According to another aspect, the dispensing machine comprises a magazine of container sealing elements, suitable for sealing the containers of the container magazine. The handling system can move from the delivery zone to the sealing element magazine, where the container into which at least one paint has been delivered in the delivery zone is sealed by a sealing element stored in the sealing element magazine. The container is sealed or capped automatically, inside the dispensing machine, thereby allowing complete automation that requires no specialised operators during normal operation.

According to a particular aspect, the container is sealed after delivery by means of a capping unit. The capping unit preferably comprises a system for lifting the container in order to press it against the bottom sealing element of a stack of sealing elements stored in the sealing element magazine. In this way the container is capped by pressure, and lowering it subsequently causes the sealing element fixed to the container to be extracted automatically from the stack of sealing elements above it.

According to another aspect, a device is described for picking cup-type containers stacked in a magazine on board a dispensing machine for fluid products such as paints and colourants. The device for picking cup-type containers comprises a member for supporting and detaching a lower container from a stack of cup-type containers inserted inside one another. The support and detachment member can preferably be activated from a position in which it supports the stack of cup-type containers supporting a projecting edge of a lower container, to a detachment position in which it inserts a wedging member between the projecting edge of the lower container and the projecting edge of a higher container inserted in the lower container. This support and detachment system is particularly efficient, reliable, simple to produce and inexpensive.

According to a particular aspect, the support and detachment member comprises a lower disc and an upper disc superimposed on one another and movable in rotation about a common axis. The peripheral edge of the superimposed discs is the right size to interfere with the projecting edge of the stacked empty containers except in a curved zone, produced in an angularly different position on each of the superimposed discs.

According to a particular aspect the wedging element of the support and detachment member is produced on the lower disc close to its curved zone. Preferably, the support and detachment member comprises a tab that can move in rotation together with the superimposed discs in order to identify and indicate easily an angular reference position.

The device for picking cup-type containers can be incorporated into a magazine for cup-type containers on board a dispensing machine for fluid products such as paints and colourants. The magazine can comprise at least one picking device positioned alongside a corresponding stack of stacked containers held in position by a framework mounted on a support plate with at least one hole through which the containers released from the picking device can emerge.

According to another aspect, a device is described that indicates the reserves of a fluid contained in a paint or colourant tank. The reserve indicator device comprises a base support to which a movable support is linked so as to oscillate. The paint or colourant tank is fixed to the movable support. Resilient means or members are positioned between the base support and the movable support. The movable support can move from a position resting on the base support, when the weight of the fluid contained in the tank is greater than a predetermined threshold and is sufficient to resist the pressure from the resilient means or members, to a position raised from the base support under the pressure of the resilient means, reached when the weight of the fluid contained in the tank falls below the predetermined threshold. A sensor system detects that the movable support has been displaced relative to the base support. This system for indicating the reserves of a fluid is simple, particularly efficient, and highly flexible and adjustable depending on specific operating requirements, the nature of the fluid, and the capacity and size of the tank. Preferably, but non-restrictively, the resilient means or members comprise a preloaded helical spring. However, the use of equivalent resilient members is not ruled out, whether they are of the fully mechanical type or the electromechanical, magnetic or other type.

According to a particular aspect, on the base support of the reserve indicator device there is mounted a volumetric pump, which pump is connected to the tank, mounted on the support, by at least one extendable or flexible conduit. In this way a compact, integrated unit is produced, comprising tank, pump and reserve indicator device, which can easily and rapidly be replaced in its entirety if necessary for maintenance. Preferably, the volumetric pump is fitted at least partly under the tank connected thereto, to make the whole more compact.

According to another aspect, a dispensing machine for fluid products such as paints and colourants comprises two or more tanks for fluid products, each mounted on a respective movable support of a respective fluid reserve indicator device. Preferably, the resilient means or members of each of the indicator devices associated with the respective fluid product tanks are calibrated so as to raise the movable support when the lower threshold is exceeded by a given value by weight.

With particular reference to the device for capping cup-type containers filled with fluid products, a description is given of a magazine of sealing elements stacked in a stack. The capping device comprises a member for supporting a container to be capped. The capping device comprises a platform that can move from a rest position, separate from and below the bottom of the container, to a capping position in which it pushes the bottom of the container so as to lift the upper edge of the container until it presses against the lower sealing element in the stack of sealing elements.

According to another aspect, the capping device comprises a member for clamping at least a lower portion of the stack of sealing elements. The clamping member can move from a release position in which it does not clamp the stack of sealing elements, to an active clamping position when the movable platform is in the capping position.

Preferably, the movable platform of the capping device is coupled to a rod controlling the clamping member. Preferably, the clamping member comprises a pair of jaws articulated about a pivot and each comprising one stem converging on the other stem when acted upon by a resilient element. Preferably, the stems of the jaws are held apart from each other in the position for releasing the clamping element, in contrast with the action of the resilient element. This special feature makes the capping device simple, reliable, and fast in operation. Preferably, the sealing elements are substantially flat and stacked on top of each other to form a stack held laterally by support columns.

According to another particular aspect, the sealing element magazine is supported by a support plate. An opening is made on the support plate to allow the sealing elements to pass under the support plate. Resilient retaining elements for supporting the stack of sealing elements from below protrude into the opening.

According to another particular aspect, the movable platform in the capping device is activated by a rod-crank mechanism.

A dispensing machine for producing paint samples is described, said machine comprising at least one container magazine, at least one delivery unit for delivering at least one fluid product into a container picked from the container magazine, and a device for capping the container into which the at least one fluid product has been delivered.

According to another aspect, a covering device is described for covering the ends of the delivery conduits of a dispensing machine for fluid products such as paints and colourants. The covering device comprises a nozzle centre in which the ends of the delivery conduits converge. A sealing member is positioned under the nozzle centre, so as to move from a covered position, in which it defines a sealed chamber together with the nozzle centre, and an open position, in which the nozzle centre is uncovered for delivery of fluid products. The device comprises a collection container inside which quantities of the fluid product drained from the delivery conduits are collected. The device can later move into a drainage position in which the drainage collection container is positioned under the nozzle centre to collect the material drained from the delivery conduits. This device proves particular effective, fast and reliable in use. Preferably, the drainage collection container can be removed. Advantageously, it is possible to extract and empty the drainage collection container even when the nozzle centre is covered by the sealed chamber without impairing its humidification. Preferably, the drainage collection container can be replaced. In this way it is possible to use inexpensive, disposable containers as drainage collection containers, without the need to clean or wash the same drainage container every time.

According to a particular aspect, the covering device comprises a saddle that can slide on guides along a rectilinear path. The saddle comprises at least one covering zone comprising a basin that can be positioned under the nozzle centre so as to produce a sealed chamber together with this, and at least one opening through which fluid products can pass, in addition to the drainage collection container. The movement of the saddle is simple to produce and is reliable. Preferably, the saddle is controlled by a linear actuator. The opening, the covering zone and the drainage container are aligned relative to each other along the axis of actuation of the linear actuator. According to another particular aspect, the covering device comprises a humidifying material suitable for humidifying the atmosphere of the sealed chamber when the device is in the sealed position.

A description is given of a dispensing machine for producing paint samples, comprising at least one delivery unit for delivering paints and/or colourants. The delivery unit comprises a plurality of delivery conduits converging in the nozzle centre, below which a covering device is mounted so that it can move.

According to another aspect, a method is described for producing paint samples by means of a dispensing machine of the aforementioned type comprising the phases of delivering at least one of the at least two main paints by means of the at least one respective main pump, and delivering at least one of the plurality of colourants by means of the at least one respective colourant pump. According to a particular aspect, a phase is provided for picking an empty container from a container magazine, transferring it by means of a handling system to a common delivery zone for the main paints and the colourants, and delivering at least one main paint into the empty container. The filled container is preferably transferred by means of the handling system to a capping station for capping the container. Preferably the container is then transferred to a delivery compartment accessible from outside the dispensing machine.

According to another aspect, a method is described for delivering fluid products using a paint and colourant dispensing machine. The dispensing machine comprises a main delivery unit for delivering paints. The main delivery unit is provided with at least one main delivery pump having a first swept volume for delivering at least one paint. The dispensing machine comprises a colourant delivery unit. The colourant delivery unit is provided with at least one colourant delivery pump having a second swept volume, less than the first swept volume, for delivering at least one colourant. The delivery of at least one colourant takes place by distributing the delivery time for the colourant delivery pump over most of the time to deliver at least one paint via the main delivery pump. “Most of” means that the period of delivery of the colourant delivery pump is as close as possible to the period of delivery of the main delivery pump. Naturally, the exact period of delivery of each colourant pump depends on the actual amount of colourant to be delivered in order to produce a particular paint, and on the minimum resolution that the relevant pump is capable of achieving. In this way good uniformity of distribution of the colourant(s) within the main product is achieved, so as to make it easy and fast to subsequently homogenise the finished paint by agitating the paint container.

According to a particular aspect, delivery of the at least one colourant starts shortly after the start of delivery of the at least one paint and ends just before the end of the delivery of said at least one paint. Advantageously, the at least one colourant is substantially incorporated, at the end of delivery, into the at least one paint, without bathing the walls or bottom of the container into which the delivery has taken place.

According to another aspect, at least two paints are delivered with the speed of delivery being adjusted by the respective main delivery pumps so as to start and end delivery of the at least two paints simultaneously.

According to another aspect, at least two colourants are delivered while the speed of delivery is adjusted by the respective colourant delivery pumps so as to start and end delivery of the at least two colourants simultaneously.

According to another aspect, the dispensing machine comprises a humidification device integrated into the nozzle centre. Preferably, the integrated humidification device effects the humidification of the delivery spouts for the fluid products when requested selectively and preferably also, though not exclusively, continuously. Advantageously the integrated humidification system comprises an annular humidification chamber for the homogeneous humidification of the whole set of delivery spouts on the circumference of the nozzle centre. According to a particular aspect, the integrated humidification device comprises a nozzle centre composed of two components. Preferably, the two components of the nozzle centre are an outer annular body and a central cylindrical portion. The annular humidification chamber is produced as a cavity between the two components of the nozzle centre. The nozzle centre comprises a delivery chamber into which the delivery spouts emerge. The integrated humidification device comprises a deflector, preferably shaped like a small plate, which distributes the humidified air homogeneously into the delivery chamber.

### BRIEF DESCRIPTION OF THE FIGURES

Further features and advantages will become apparent from the following detailed description of some preferred embodiments of the invention, given purely by way of non-restrictive example, with reference to the accompanying drawings, in which:

FIG. 1 is a perspective view of a dispensing machine according to the present invention;

FIG. 2 is a side view in elevation of the machine in FIG. 1, without its external bodywork;

FIG. 3 is a perspective view of a support plate and work stations of the machine according to the present invention;

FIG. 4 is a view in elevation of the support plate and work stations in FIG. 3;

FIG. 5 is a side view in the direction of the arrow V in FIG. 4;

FIG. 6 is a plan view in the direction of the arrow VI in FIG. 4;

FIG. 7 is a view from below in the direction of the arrow VII in FIG. 4;

FIG. 8 is a perspective view of a lower saddle for supporting paint tanks;

FIG. 9 is a view in front elevation of the lower saddle in FIG. 8;

FIG. 10 is a side view in the direction of the arrow X in FIG. 9;

FIG. 11 is a plan view in the direction of the arrow XI in FIG. 9;

FIG. 12 is a section through a volumetric pump used the machine of the present invention;

FIG. 13 is a perspective view of a colourant delivery unit;

FIG. 14 is a side view in the direction of the arrow XIV in FIG. 13;

FIG. 15 is a perspective view of a humidification unit of the nozzle centre;

FIG. 16 is a perspective view of a handling unit;

FIG. 17 is a perspective view similar to FIG. 3, from which the illustration of the colourant delivery unit has been omitted for the sake of clarity;

FIG. 18 is a perspective view from below of the assembly of components in FIG. 17;

FIG. 19 is a view in side elevation of the assembly of components in FIGS. 17 and 18;

FIG. 20, 22, 24, 26 are perspective views, on an enlarged scale, of a member for picking empty containers, in four different operating phases;

FIG. 21, 23, 25, 27 are respectively sections through the views shown in FIG. 20, 22, 24, 26;

FIG. 28 is a section, on an enlarged scale, of a detail of the capping systems for the paint containers;

FIG. 29 is a plan view of the system for clamping a stack of caps in the capping system.

FIG. 30 is a side view of a member for lifting a paint container under the delivery unit, in a lowered rest position;

FIG. 31 is a view similar to FIG. 30, with the lifting member in a position to start lifting the paint container towards the delivery nozzle centre;

FIG. 32 is a view similar to FIGS. 30 and 31, with the lifting member in a position for lifting the paint container up against the delivery nozzle centre;

FIG. 33 is a section through the nozzle centre comprising an integrated humidification system; and

FIG. 34 is a section through the nozzle centre in FIG. 33, along a different section plane.

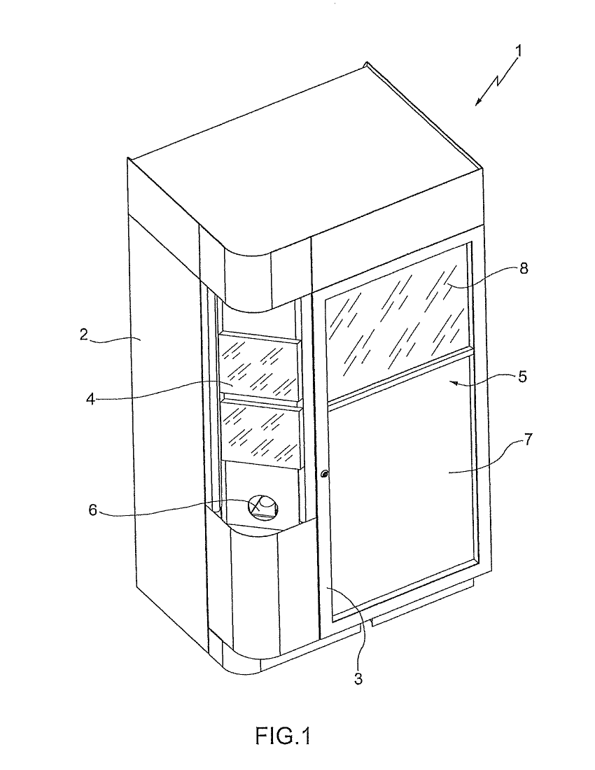

### DETAILED DESCRIPTION

With reference now to the figures, the numeral 1 indicates a machine according to the invention for producing paint containers or pots, in particular samples of coloured paint. The machine comprises a bodywork 2 with an access door 3 into said machine, expediently kept locked shut to prevent unauthorised access. A video screen 4 is mounted on the bodywork 2, for user interface and to display information on the operation of the machine. The video screen 4 can be of the “touch screen” type and therefore also functions as a data entry device. Alternatively, other systems for data entry by users or service staff can be provided, such as a tablet, a latest generation telephone with Internet connection, a keyboard, a mouse, a joystick, a button panel and the like.

Under the video screen 4, in a convenient position for collection by a user, a collection compartment 6 is opened, into which, at the end of the production operations by the machine 1, the pot of paint requested by the user is delivered. On one side 5 of the bodywork 2 a colour chart 7 is preferably displayed, with the necessary codes and details so that a user can easily choose the desired colour tone. On the side 5 of the bodywork 2, a second video screen 8 can be mounted, for displaying advertising messages and/or for displaying the colour chart 7 in electronic form. The video screen 8 can be positioned vertically, also occupying the space of the colour chart in paper form 7.

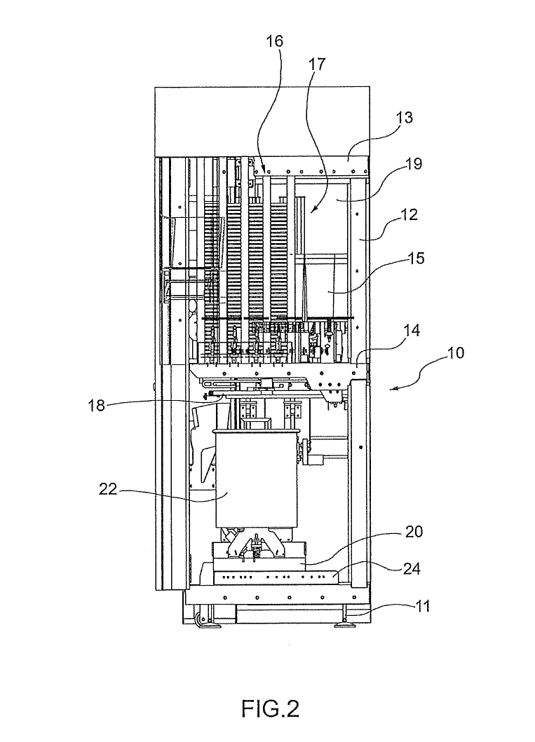

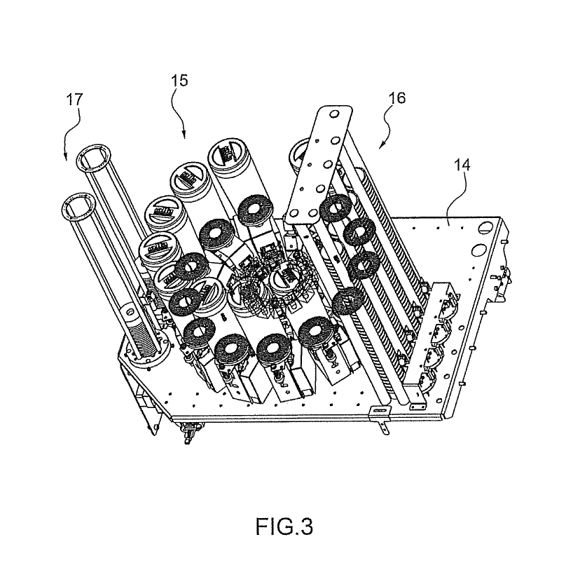

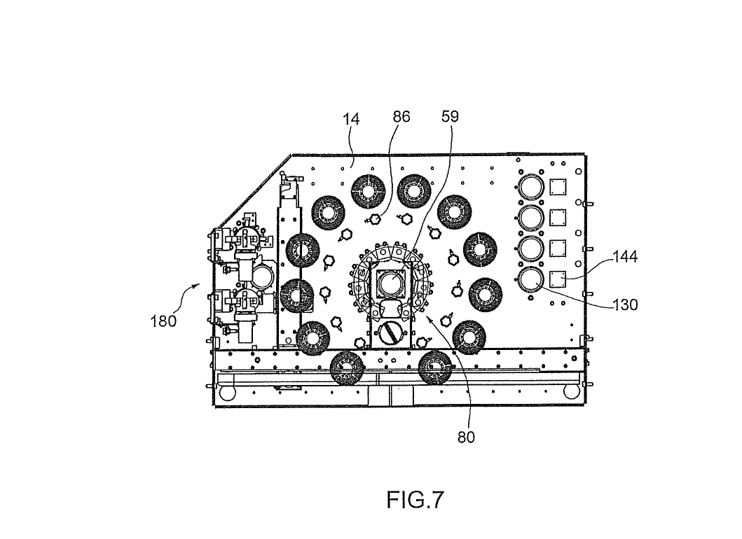

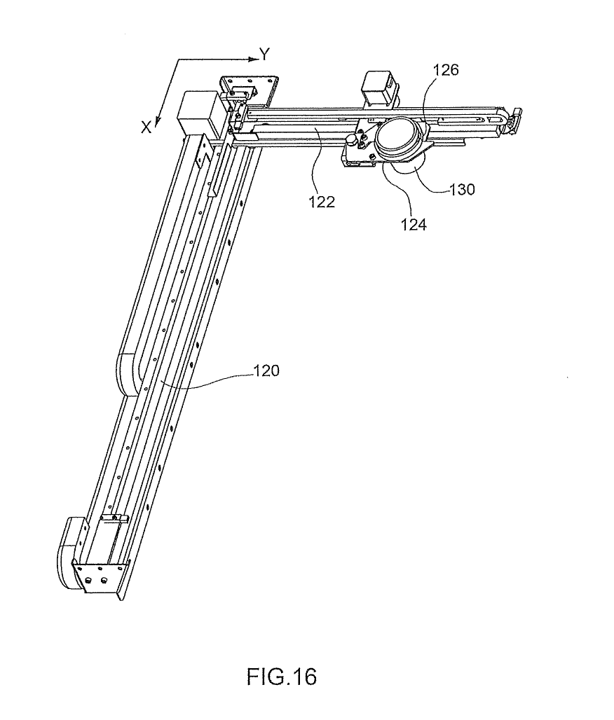

As can be seen from FIG. 2, the bodywork 2 is supported by a frame 10 that rests on height-adjustable feet 11 in order to adapt and level the machine 1 for any unevenness of the flooring. The frame 10 comprises uprights 12 connected by cross-pieces 13. A support plate 14 is fixed to the uprights 12 in a substantially median position with respect to the overall height of the frame 10. As can be seen clearly also in FIGS. 3 to 7, the following are mounted on the support plate 14: a colourant delivery unit 15, a container magazine 16 and a capping station 17 comprising a magazine of caps or covers, and a capping unit, as described in more detail below. A handling unit 18 is fixed below the support plate 14 (see also FIG. 16). An electronic control unit 19 is mounted on the side of the frame 10.

In the lower portion of the frame 10, a saddle 20 is mounted, to support paint tanks indicated generically with the reference numeral 22. In the example in the figures, two paint tanks 22a, 22b are depicted, these being particularly suitable for actuating the method for producing paints by mixing fluid products as referred to in Italian patent application no BO2014A000562 from the same applicant, the contents of which are incorporated in their entirety into the present patent application. In this method a set of fluid products is provided, comprising at least a white paint, containing a predetermined percentage amount of titanium dioxide, and at least a neutral paint with no colourants. An empty container is then provided, which is filled with a predetermined amount of paint obtained by mixing the white paint and the neutral paint in proportions that can vary between 0% and 100%. This results in a paint with a titanium dioxide content selected between a maximum, corresponding to the titanium content of the white paint, and 0%, corresponding to the titanium content of the neutral paint. The two paint tanks 22a, 22b mounted on the saddle 20 can conveniently contain respectively the white paint and the neutral paint mentioned above. Naturally, the number of tanks 22 housed on the saddle 20 is not limited to two, since the machine 1 can easily be modified so as to house just one tank 22, or a plurality of tanks 22 greater than two, on the saddle 20. In this way the machine 1 can be adapted for producing paint according to methods other than that described in Italian patent application no BO2014A000562.

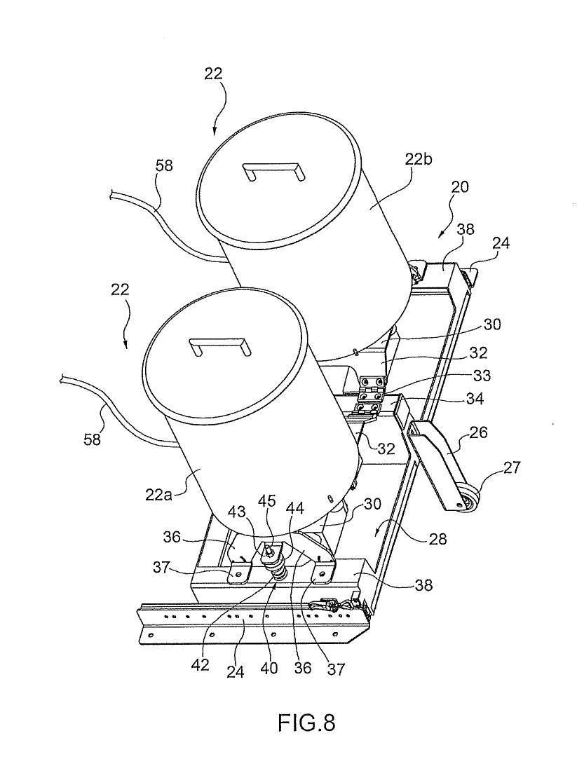

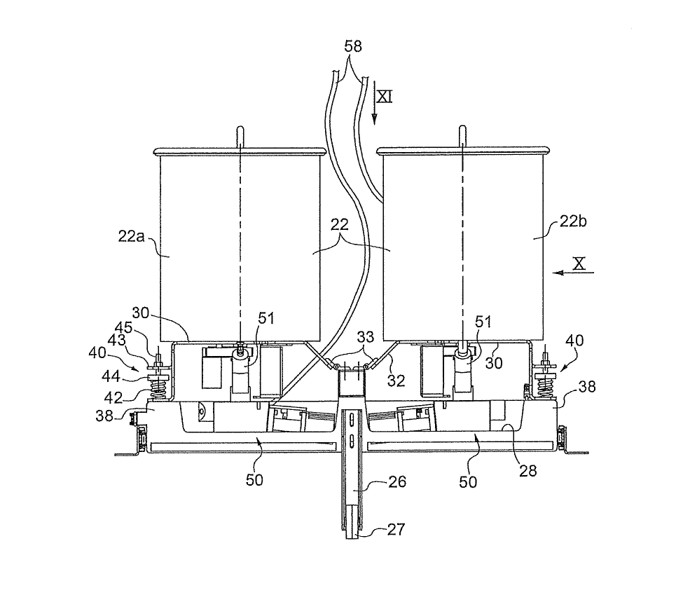

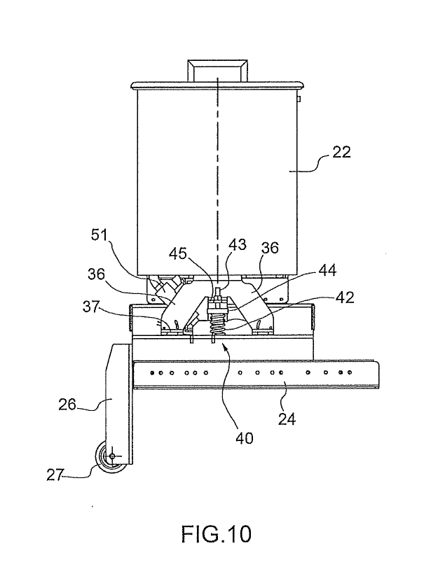

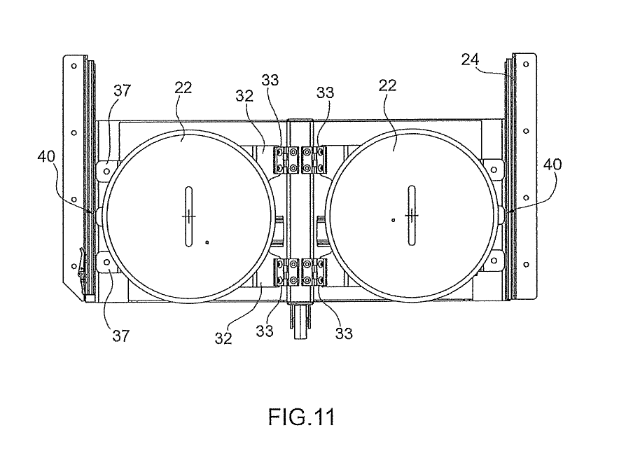

As can be seen more clearly in FIGS. 8 to 11, the saddle 20 is mounted on two sliding guides 24 positioned at its sides and fixed to the lower portion of the frame 10. A central support stem 26, provided with a wheel 27 at its end, is fixed in a frontal zone of the saddle 20, substantially equidistant from the two sliding guides 24. Thus, the weight of the saddle 20 is supported not only by the two sliding guides 24 but also by the central stem 26, which bears on the wheel 27. This is particularly advantageous when the tanks 22a, 22b are full of paint and the saddle 20 is in the extracted position, projecting out of the frame 10.

The tanks 22a, 22b are mounted raised above the bottom 28 of the saddle 20 by means of a support plate 30 which, on one side, has two hinged branches 32 that allow the support plate 30 to oscillate about a horizontal axis. The hinged branches are mounted so as to oscillate by means of hinges 33 connected to a transverse central wall 34 positioned on the centre-line of the saddle 20. On the side opposite the hinges 33, the support plate 30 has two support branches 36 that end in two horizontal tabs 37 that can bear on a raised side wall 38 positioned on one side of the saddle 20.

An indicator device 40 for indicating that a reserve level of the paint contained in the tank 22 has been reached is placed between the raised side wall 38 and the support plate 30, on the side of the support branches 36 opposite the hinged branches 32. The indicator device 40 comprises a resilient member, preferably but not restrictively a helical spring 42, which presses between the raised side wall 38 and an appendage 43 of the support plate 30, with an interposed thrust washer 44 fixed to the appendage 43 adjustably, by means of a threaded connection 45. The spring 42 remains compressed until the amount of fluid product in the tank 22, and therefore its total weight, is greater than a predetermined value, adjustable during calibration of the machine 1 by acting on the threaded connection 45. When the fluid product in the tank 22 falls below said predetermined value, the pressure from the spring 42 overcomes the total weight of the tank 22 and causes the horizontal tabs 37 to lift up from the raised side walls 38, causing the support plate 30 to oscillate. This oscillation causes a signal to be activated, for example by activation of a microswitch (not shown in the figures), which is intercepted by the electronics of the machine 1. The signal indicates that a predetermined minimum level of fluid product has been reached in the tank 22. The indicator device 40 is activated by a predetermined weight of fluid product contained in the tank 22. Once the specific weight of the fluid product is known, the electronics of the machine 1 is able to determine the volume of fluid product remaining in the tank 22. This information can be used for calculation purposes in the system for producing paint by means of the machine 1 and, where necessary, can be transmitted to remote systems, displayed on the video screen 4 and/or used to generate an alarm.

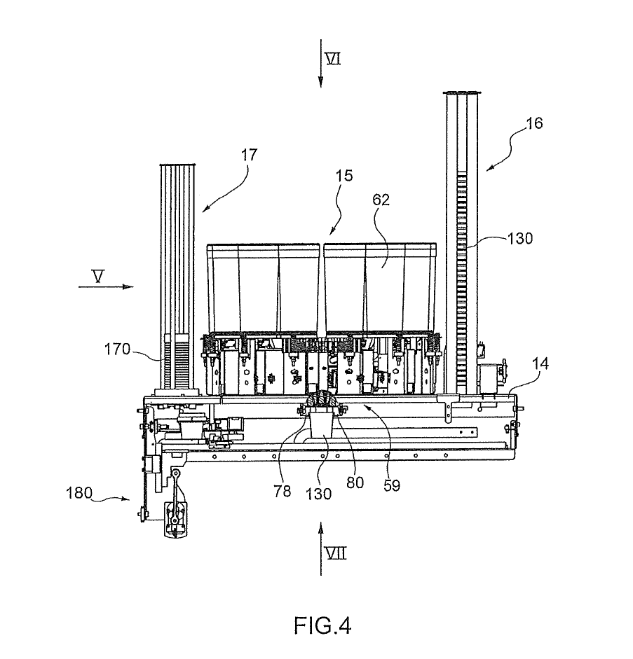

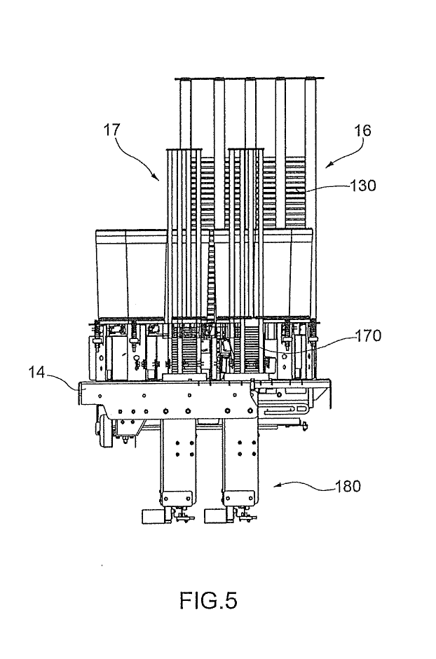

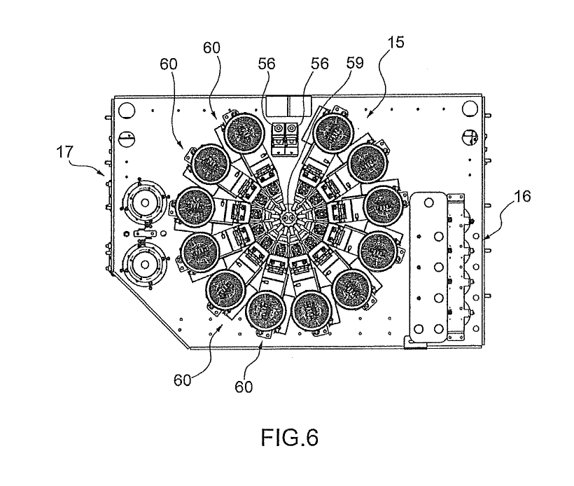

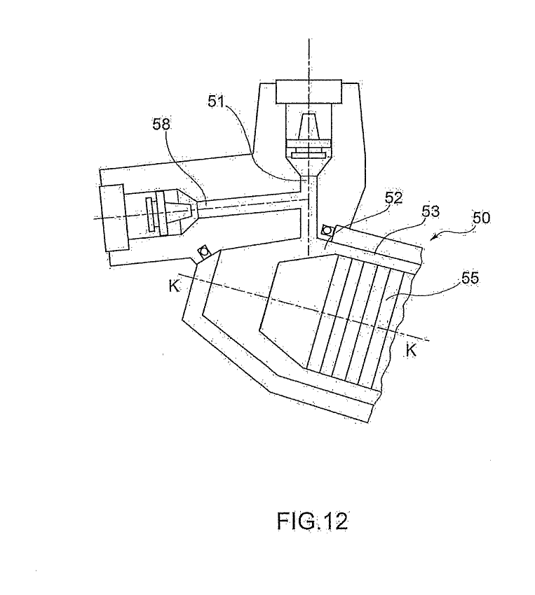

On the saddle 20, below the tank 22, main delivery pumps 50 are mounted, preferably of the volumetric type, and particularly, although non-restrictively, of the type described in the aforementioned Italian patent applications nos BO2014A000555, BO2014A000556 and BO2014A000557 made by the same applicant, the content of which is incorporated in its entirety into the present patent application. In particular, as can be seen in FIG. 12, each main delivery pump 50 comprises a pumping chamber 53 inside which a piston 55 is mounted slidably, the forward and backward movement of which is controlled so as to vary the effective volume of the pumping chamber 53. The pumping chamber 53 extends along a longitudinal axis K-K inclined relative to a horizontal plane, and has a peak zone 52 positioned at the highest part relative to a horizontal plane and in the region of which the pumping chamber 53 is put into communication with at least one suction conduit 51 for a fluid product contained in the tank 22. A respective feed conduit 58 extends from the respective main delivery unit pump 50 to a nozzle centre 59 (see FIG. 4) positioned at the centre of the colourant delivery unit 15 mounted on the support plate 14, with an interposed respective electrovalve 56 (see FIG. 6) fixed to the support plate 14, from which a recirculation conduit (not visible in the figures) branches off, returning the fluid product to the respective tank 22.

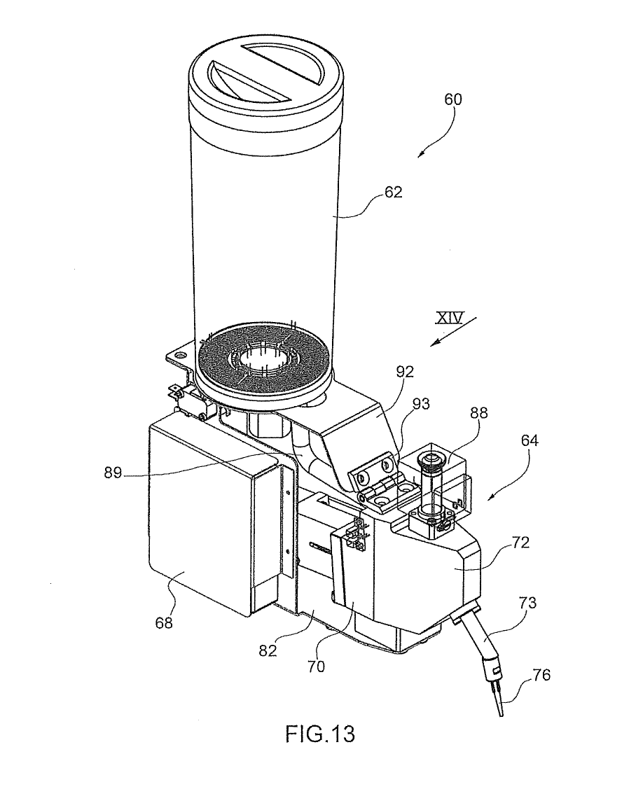

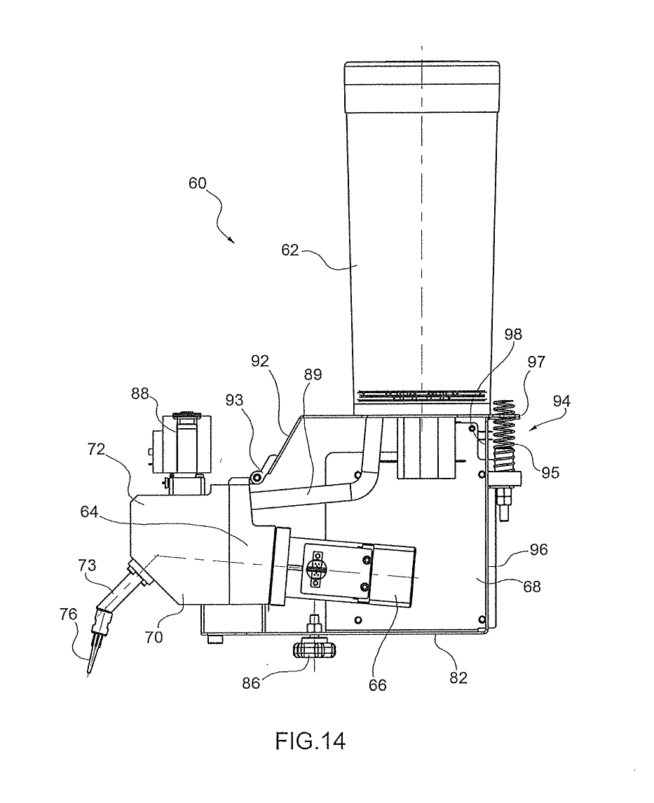

The colourant delivery unit 14 is composed of a plurality of colourant delivery modules 60 identical to each other and positioned radially around the nozzle centre 59. As can be seen more easily in FIGS. 13 and 14, each colourant delivery module 60 comprises a colourant tank 62 and a colourant delivery pump 64 controlled by a motor 66, itself controlled by an electronic device 68 connected to the general electronics of the machine 1. Each colourant delivery pump 64 is preferably of the volumetric type, and in particular, although non-restrictively, of the type described in the aforementioned Italian patent applications nos BO2014A000555, BO2014A000556 and BO2014A000557. In particular, it is expedient for the colourant delivery pumps 64 to have similar or identical structural and control characteristics to those of the main delivery pumps 50, but to be made with a smaller swept volume, since the amounts of colourants to be delivered in order to produce the finished paints with the machine 1, in particular according to the method described in the aforementioned Italian patent application BO2014A000562, are very much smaller than the amounts of white or neutral paint contained in the tank 22. The small swept volume of the colourant delivery pumps 64 makes it possible, on the other hand, to achieve very high-precision delivery of the colourants, with an appreciable result from the point of view of exactly reproducing a very large number of shades and colour tones. Furthermore, the larger swept volume of the main delivery pumps 50 permits outstanding speed when filling the finished paint containers and therefore high productivity of the machine 1, or at any rate a short time for the user to wait between requesting a particular paint and its delivery in a container that is delivered into the collection compartment 6 according to procedures that will be explained in greater detail below.

In the example in the figures, the colourant delivery unit 14 comprises eleven colourant delivery modules 60, but naturally it is possible to increase or reduce the number thereof depending on the configuration requirements of the machine 1. Simply by way of example, the possibility can be mentioned of reducing the number of colourant delivery modules 60 to eight, though they could for example be increased to sixteen. As already stated, each colourant delivery module 60 comprises a colourant delivery pump 64 with a pump body 70 having a front portion 72 that is wedge-shaped so as to produce, together with the corresponding front portions 72 of the adjacent pump bodies 70, a very compact portion of a radial pattern, allowing the footprint of the machine 1 to be kept very small and also making it possible to reduce to the minimum the segment of delivery conduit 73 that emerges from the front portion 72 into the nozzle centre 59. The fact that the segment of the delivery conduit 73 is very short is advantageous because it allows losses of load during delivery of the colourants to be reduced to the minimum, consequently increasing the accuracy and repeatability of delivery. Furthermore, when a colourant is not being delivered, the short segment of delivery conduit 73 contains a very small amount thereof, which it is easier to keep homogeneously dispersed. The diameter of the delivery spout is very small in order to prevent the formation of a denser skin, according to methods described below, since these would impair the accuracy and repeatability of delivery of that colourant. It should be remembered that the amounts of colourants to be delivered in order to produce a particular shade of paint, specially a small amount of paint such as that contained in the colour samples produced by the machine of the present invention, are sometimes extremely small. The colourant delivery pump 60 used in the machine 1 of the present example is able to deliver very small quantities. To derive the full benefit from such high precision, it is advisable for the delivery conduit 73 be as short as possible.

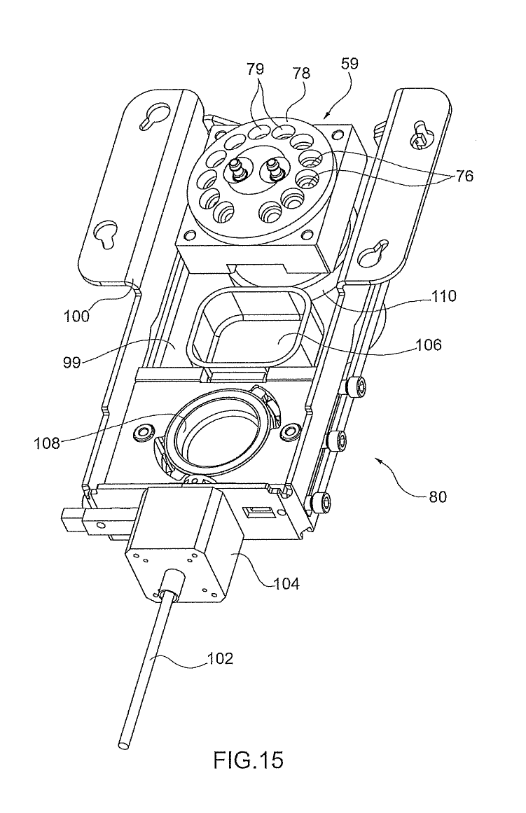

The end of the delivery conduit 73 ends in a delivery spout 76. Preferably the delivery spout 76 can be dismounted and replaced. The nozzle centre 59 comprises a disc-shaped support 78 (see FIG. 15) with a plurality of holes 79 into which the delivery spouts 76 are embedded. Preferably the holes 79 are positioned along an annular crown on the disc-shaped support 78. The feed conduits 58 coming from the main delivery pumps 50 emerge at the centre of the annular crown formed by the holes 79.

The nozzle centre 59 is fixed to the support plate 14 in an opening therein, so that the delivery spouts 76 emerge below the support plate 14. A humidification device 80, whose characteristics will be described more precisely below, is fixed so that it can move under the support plate 14.

In each colourant delivery module 60, the pump body 70 is fixed to a base plate 82 that can be fixed to the support plate 14 so as to be easy to dismantle, for example for maintenance or replacement, for example by means of a screw 86. An electrovalve 88 is mounted on the pump body 70, said electrovalve putting the pumping chamber (not illustrated) of the colourant delivery conduit pump 64 into communication, when commanded, alternately with the delivery conduit 73, to deliver an amount of fluid contained in the pumping chamber to the delivery spout 76, or with a feed conduit 89 communicating with the colourant tank 62. In the situation where there is communication of fluid between the pumping chamber of the colourant delivery pump 64 and the colourant tank 62 it is possible, depending on the actuation of the colourant delivery pump 62, to produce either suction of colourant from the colourant tank 62 to the pumping chamber or—conversely—recirculation of colourant from the pumping chamber to the colourant tank 62.

The colourant tank 62 is fixed to an oscillating plate 92 articulated to the pump body 70 by means of a hinge 93. Similarly to what was seen for the main delivery pumps 50, each colourant delivery pump 64 is also provided with an indicator device 94 (see FIG. 14) that indicates that a minimum level of fluid colourant contained in the colourant tank 62 has been reached. The indicator device 94 comprises a resilient member, for example a helical spring 95 fixed to a rear portion 96 of the base plate 82 of the colourant delivery module 60, which presses against a rear end 97 of the oscillating plate 92. The oscillating plate 92 stays in a support position until the colourant tank 62 contains an amount of colourant fluid greater than a certain weight. When the amount of colourant fluid in the colourant tank 62 falls below a level predetermined by the loading of the helical spring 95, the latter pushes up the rear end 97 of the oscillating plate 92 that supports the colourant tank 90, triggering a signal, for example activated by a microswitch 98 mounted on the oscillating plate 92. Similarly to what was stated in relation to the indicator device 40 for the paint tanks 22, in this case too the electronic system of the machine 1 is able to provide information and/or carry out processing based on the residual volume of colourant fluid product remaining in the colourant tank 62, if the specific weight thereof is known.

The humidification device 80 can be seen in detail in FIG. 15, and comprises a frame 99 mounted so as to slide on a guide support 100 fixed underneath the support plate 14. The forward and backward movement of the frame 99 is controlled by a linear actuator 102 actuated by a motor 104. A humidification basin 108 is produced on the frame 99. The humidification basin 108 houses a sponge or similar, which is periodically soaked in water by an operator so as to create a humid atmosphere, when it is positioned below the nozzle centre 59, substantially hermetically. The frame 99 also has an opening 110 that allows one or more colourants to be delivered into a container placed under the nozzle centre 59 and under the humidification device 80. The frame 99 also supports a drainage container 106, into which small amounts of colourant are drained during the programmed drainage operations of the delivery conduits 73 and the delivery spouts 76. Preferably, the drainage container 106 is removable, so that an operator can easily remove it to clean or replace it.

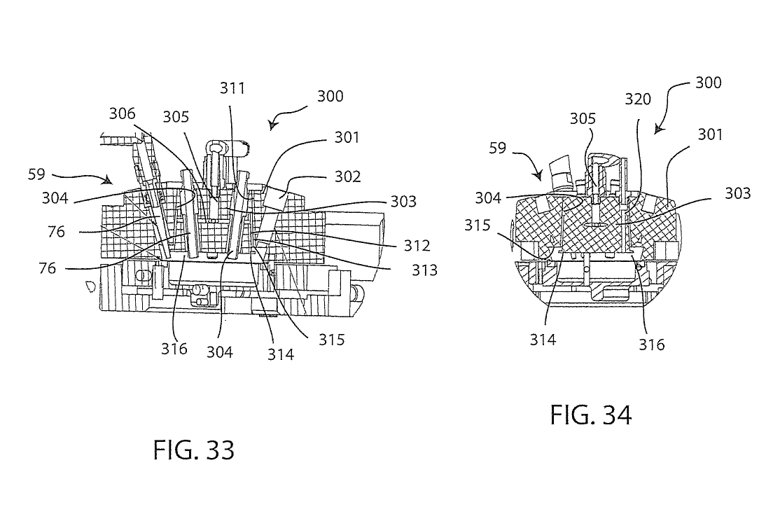

In particular conditions of use, in addition to or instead of the humidification device 80, which acts at times when no delivery is taking place, it is possible to provide a humidification system 300 incorporated into the nozzle centre 59 itself, as can be seen in FIGS. 33 and 34, which can effect the humidification of the delivery spouts 76 substantially continuously, even when for reasons of high productivity the humidification device 80 necessarily remains open for a prolonged period. The nozzle centre 59 advantageously comprises an annular body 301, in which housings 302 are made for the colourant delivery spouts 76. A central cylindrical portion 303 is housed in the central hole 304 of the annular body 301. The outer cylindrical shell of the central cylindrical portion 303 has two different diameters. A first, upper segment 311 has a diameter corresponding substantially to the central hole 304 of the annular body 301, such that the annular body 301 and the central cylindrical portion 303 can be assembled and fixed together with a certain amount of intervention. The remaining, second segment 312 of the central cylindrical portion 303, closer to the delivery zone of the delivery spouts 76, has a slightly smaller diameter than the hole in the annular body 301, so that, when in the assembled condition, a slim annular chamber 313 is produced.

Housings 304 for the delivery spouts 76 of the main paints or base paints are made in the central cylindrical portion 303. The housings 304 are arranged symmetrically about the axis of the nozzle centre 59. In line with the axis of the nozzle centre 59, in the central cylindrical portion 303, a conduit 305 is made for introducing humidified air, coming from a tank not illustrated in the figures. The conduit 305 penetrates into the central cylindrical portion 303 and communicates with a series of radial canals 306 that emerge into the slim annular chamber 313. The central cylindrical portion 303 has at its lower end a disc-type protuberance 314 shaped like a small plate and operating as a deflector, positioned a short distance from an inner wall 315 of a delivery chamber 316 produced in the annular body 301, into which the ends of all the delivery spouts emerge. If need be, humidified air is introduced into the conduit 305 and reaches the slim annular chamber 313 through the radial conduits 306. From the slim annular chamber 313, the humidified air is deflected sideways from the disc-type protuberance 314 so as to be diffused into the delivery chamber 316 and affect the ends of all the delivery spouts, humidifying them.

As can be seen more clearly in FIG. 34, inside the central cylindrical portion 303 a lead-through 320 is also made, to be used if necessary as an outlet for excess humidified air.

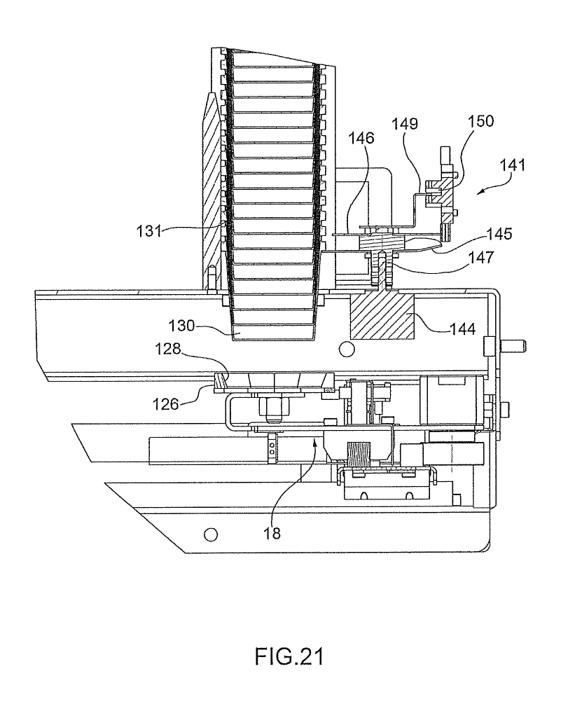

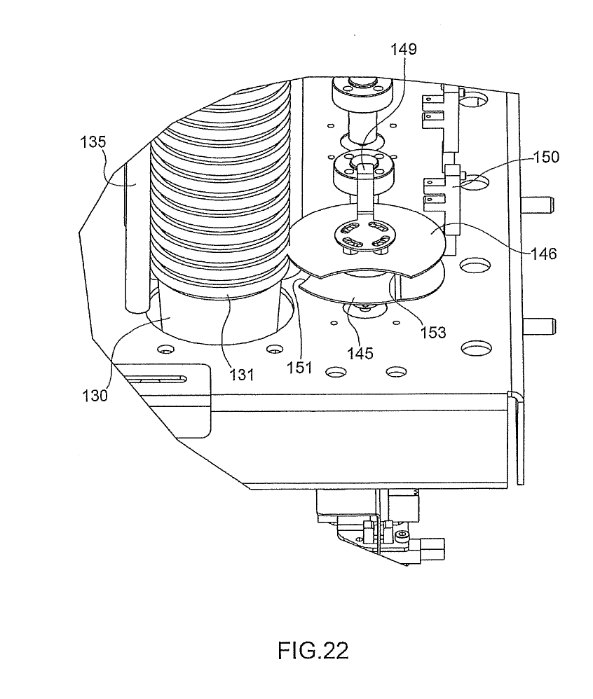

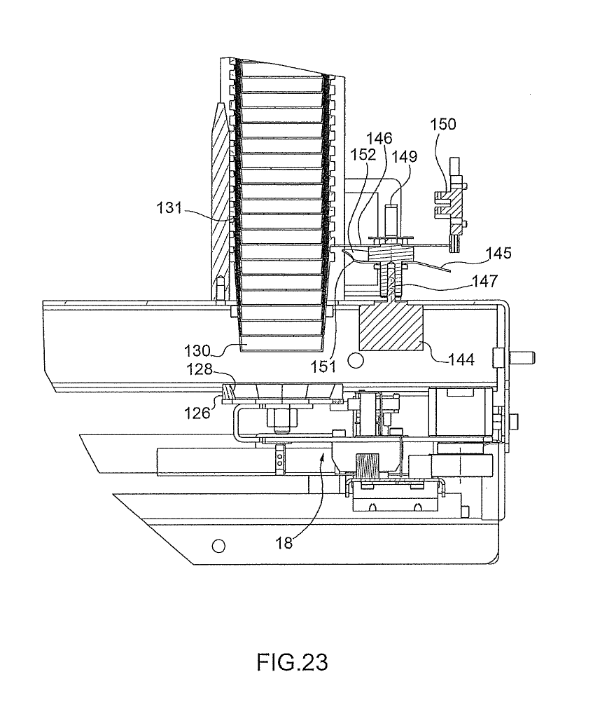

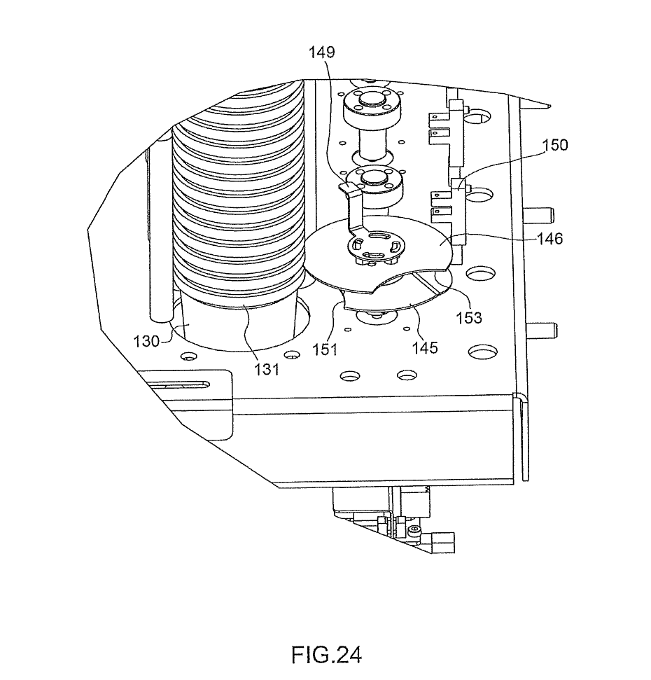

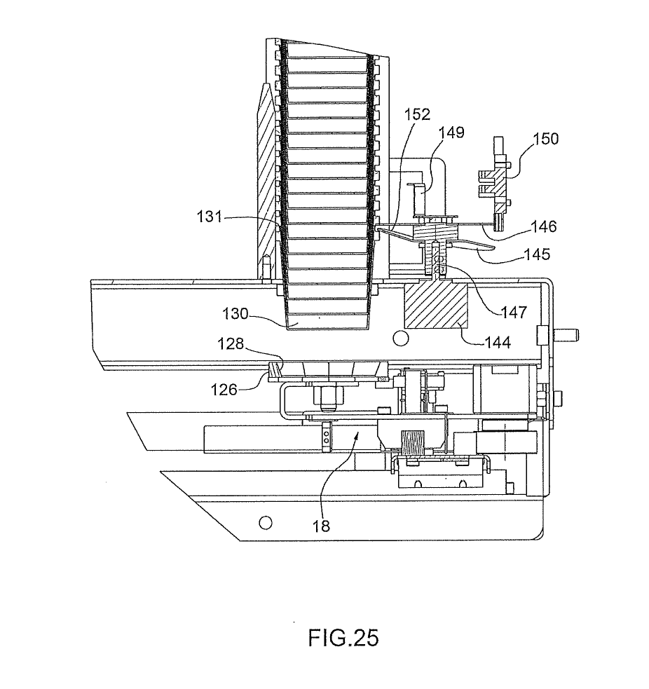

The handling unit 18 is mounted below the support plate 14 (see FIG. 16), said handling unit comprising a main arm 120, mounted on the frame 10 or on said support plate 14 and that can move in a first direction over a horizontal plane, and a secondary arm 122, mounted on the main arm 120 and movable in a second direction, orthogonal to the first direction, over a horizontal plane. A support member 124 for a container 130 is mounted on the secondary arm 122, said support member comprising for example a ring 126 (see FIG. 21) with an inner surface 128 shaped as a truncated cone to accommodate a corresponding container 130 in the form of a truncated cone. Overall, the handling unit 18 can effect positioning of the container 130 along Cartesian axes X-Y in the horizontal plane. The main arm 120 and the secondary arm 122 are actuated by respective motors.

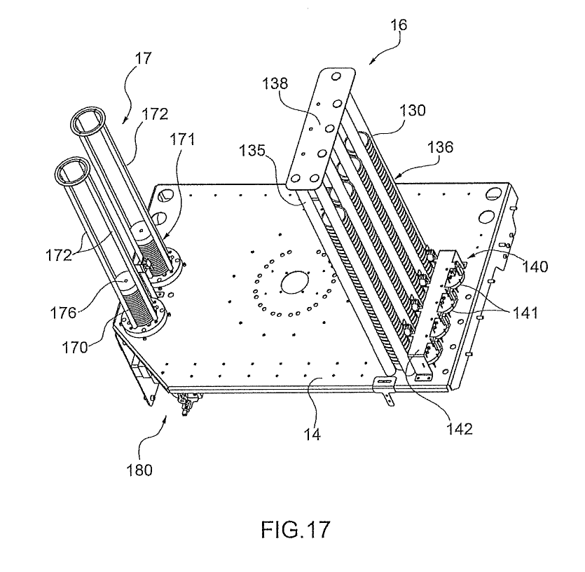

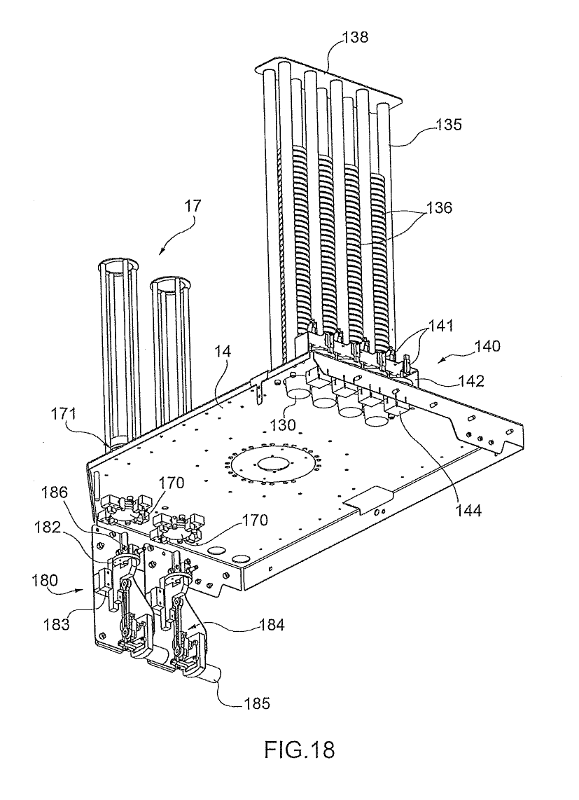

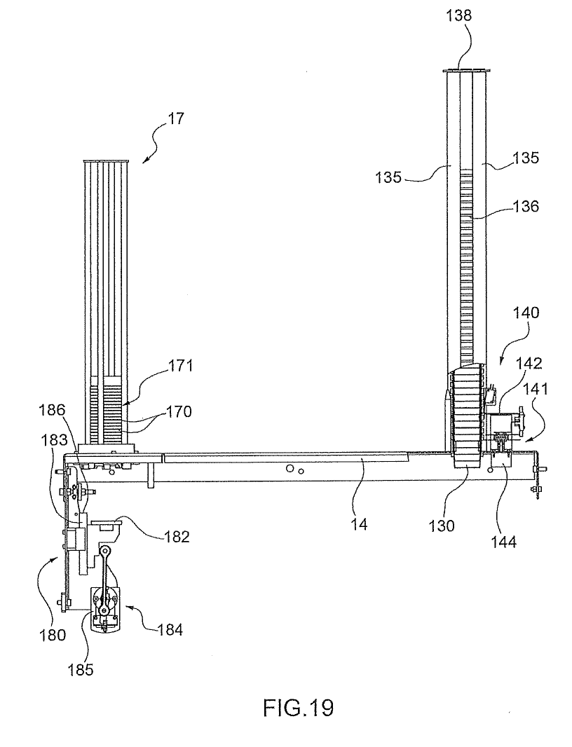

As can be seen clearly also in FIGS. 17 to 19, in which the colourant delivery unit 15 has not been depicted for clarity of illustration, the container magazine 16 can accommodate a plurality of empty containers 130, arranged stacked in several arrays. In the example in the figures there are four arrays of containers 130 in a line, but naturally the number and reciprocal positioning of the arrays of containers 130 can vary, according to storage requirements, the intended autonomy of the machine 1, and the space available inside the bodywork 2. The container magazine 16 comprises a plurality of columns 135 fixed to the support plate 14 positioned parallel to each other so as to hold four stacks 136 of containers 130 laterally. A cover 138 mounted on the upper end of the column 135 closes off the spaces containing the stacks 136 at the top. The support plate 14 has four openings corresponding to the stacks 136, to allow the containers 130 to move down onto the support member 124 of the handling unit 18.

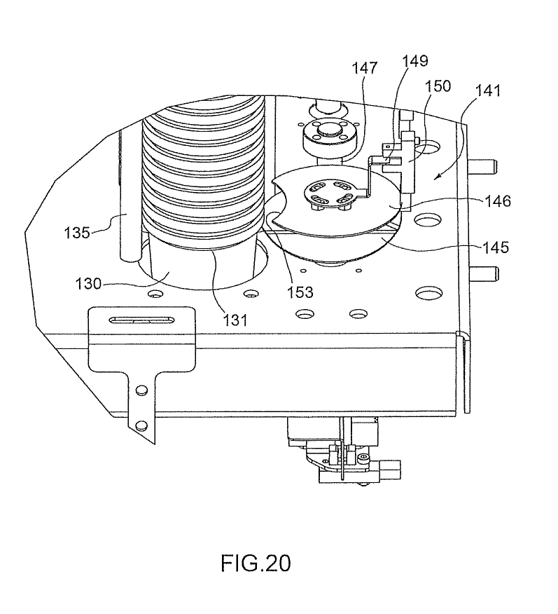

The container magazine 16 also comprises a picking device 140 placed on one side of the arrays of containers 130. The containers 130 each comprise at the top a collar 131 that is advantageously used for the picking operations. The picking device 140 comprises a plurality (four in the example in the figures) of picking members 141 mounted rotatably on a support 142, each having its rotation controlled by a respective motor 144 fixed to the support plate 14. As can be seen more clearly in FIGS. 20 to 27, a picking member 141 comprises a lower disc 145 and an upper disc 146, of the same diameter, mounted coaxially and vertically separated from each other on a control spindle 147 controlled by the motor 144. A tab 149 is mounted above the upper disc 146 and interacts with a sensor 150 to identify a given angular position thereof, corresponding to a storage position of the picking member. A half-moon shaped curved portion 151 is taken out of the lower disc 145. On one side of the curved portion 151, the lower disc 145 is bent upwards to form a detachment tooth 152 close to the lower face of the upper disc 146. The upper disc 146 itself also has a half-moon shaped curved portion 153, similar to the curved portion 151 of the lower disc 145 and offset at a 90° angle to the latter.

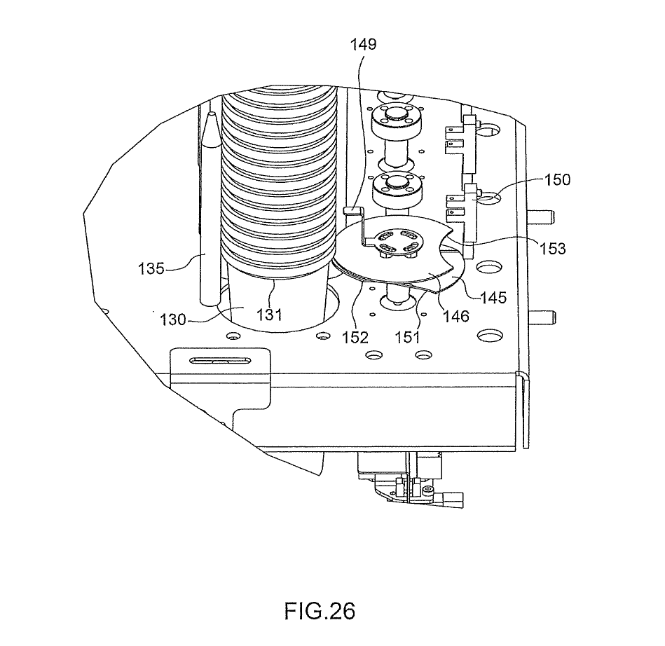

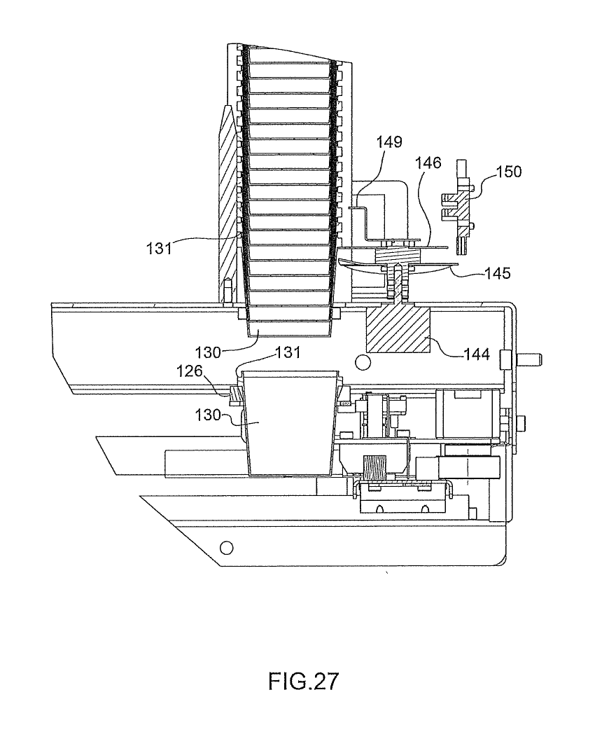

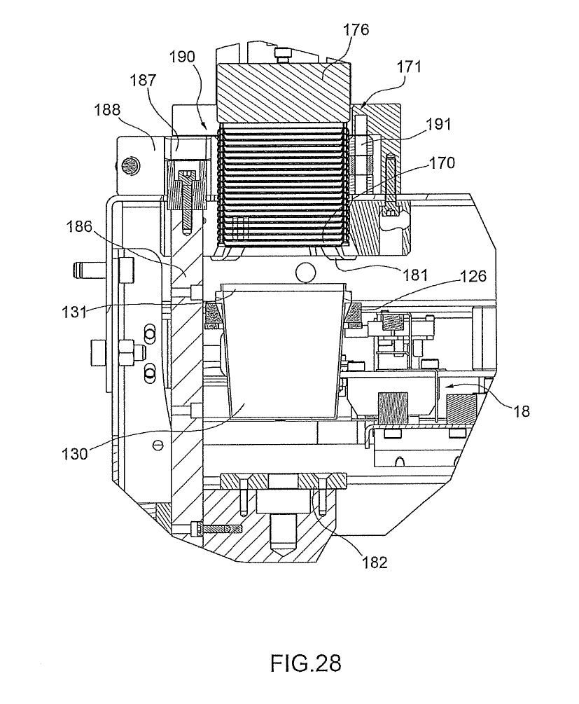

The capping station 17 (see FIGS. 17 to 19) comprises two stacks 171 each comprising a plurality of caps 170 suitable for hermetically sealing the containers 130 at the end of the operations of delivering fluid products into them, to produce the finished, full container, ready for delivery to the end user. In the example in the figures, each of the two stacks 171 is supported by four columns 172 fixed to the support plate 14. The bottom cap in each stack 171 faces a corresponding opening made on the support plate 14 so as to be accessible from below the latter, where a capping unit 180 for each stack 171 of caps 170 is positioned. Each stack 171 of caps is supported from below by flexible tabs 181 (see FIG. 28) that hold the edge of the bottom cap 170 in the stack 180. A weight 176 is placed on top of each stack 171 of caps 170.

Each capping unit 180 comprises a lifting platform 182 mounted so as to slide on vertical guides 183 and actuated in upward and downward displacement by a rod-crank unit 184 underneath it, controlled by a motor 185. The lifting platform is connected to a shaft 186, the upper end 187 of which interacts with the stems 188 of the two jaws 190 for clamping the lower portion of the stack 171 of caps 170.

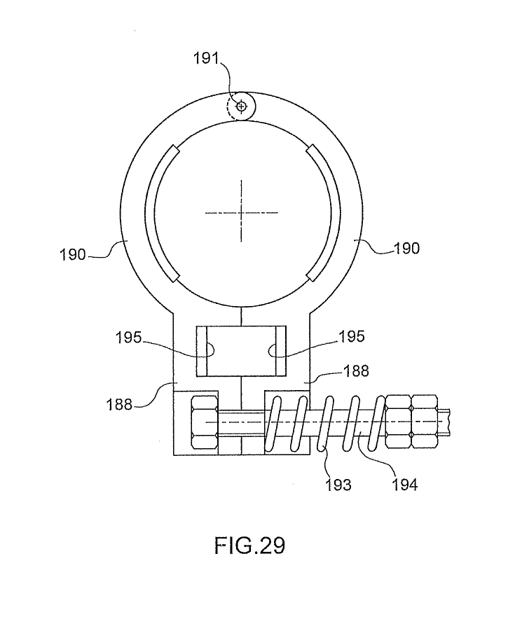

As can be seen more clearly in FIG. 29, the clamping jaws 190 are articulated together with a pivot 191 opposite the stems 188. The clamping jaws 190 are driven into the clamped position illustrated in the figure by a spring 193 mounted on a shaft 194. Two facing notches 195 are made on the stems 188, between which notches the wedge-shaped upper end 187 of the shaft 186 is inserted. The raising of the shaft 186 caused by the upward displacement of the lifting platform 182 causes the wedge on the end 187 to move away from the notches 195, which therefore come closer through the action of the spring 193 exerting a clamping pressure on the lower portion of the stack 171 of caps 170. The lowering of the shaft 186 caused by the downward displacement of the lifting platform 182 causes the wedge on the end 187 to return into the notches 195, consequently moving the clamping jaws 190 away from the lower portion of the stack 171 of caps 170.

The capping station could also be different from that illustrated in the example in the figures and could for example comprise a device of a generally known type for applying a heat-sealed film over the mouth of the container 130 full of fluid product. Another possible alternative is to position a cap 170 on the mouth of the container, and to drag the latter in a horizontal direction under a locator that presses on the cap, to fasten it. The locator can be fixed, for example a wedge-shaped plane, or movable, for example one or more rollers. The movement of the container under the locator for capping can be effected by said handling unit 18 over the horizontal plane X-Y that is used to transfer the container from the magazine to the nozzle centre.

Inside the machine 1 there is also a zone or container for collecting waste, into which the handling unit 18 effects the transfer of any part-full containers, or ones that have to be discarded in the event of malfunction or unexpected stoppage of the operations of the machine 1.

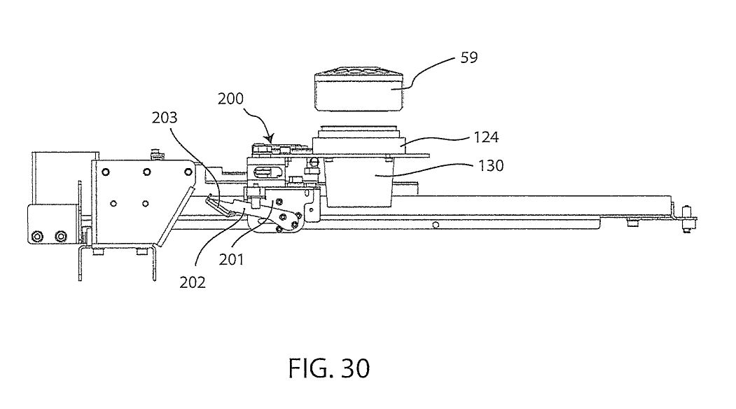

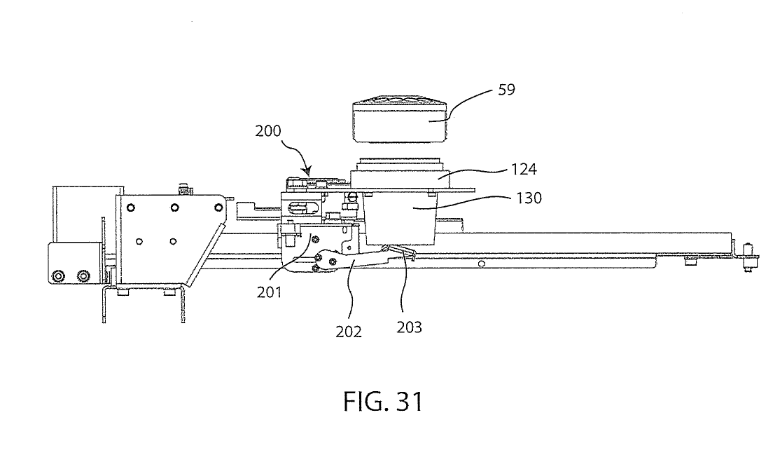

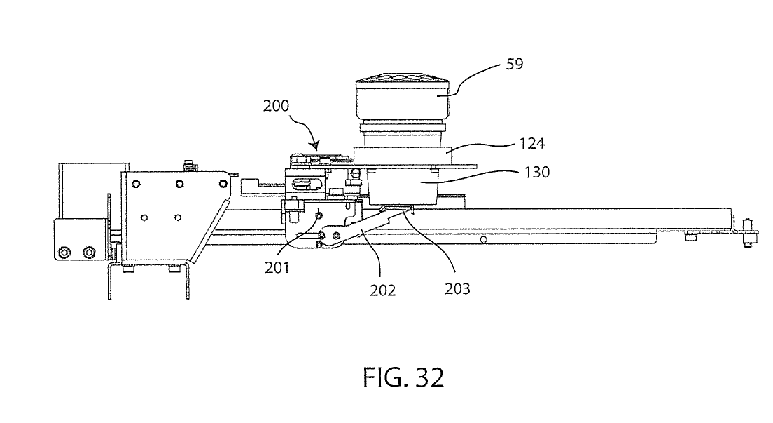

As can be seen in greater detail in FIGS. 30 to 32, the support member 124 for a container 130 can incorporate a lifting member 200, to bring the container 130 nearer to the nozzle centre 59, preferably bringing the mouth of the container 130 close to the nozzle centre 59 until it comes into contact with the latter. In this way any spillage of fluid product from the container can be prevented. The advantages are both that of keeping the inside of the machine clean, and more importantly that of producing the exact formulation of paint without spilling any drops of colourant or fluid product that could alter the expected and desired result. As can be seen in FIG. 30 to 32, the lifting member 200 comprises a support body 201 with an appendage 202 that can move in rotation, for example by means of a motor incorporated into the support body 201. The end of the appendage 202 is provided with a small plate 203 capable of pressing on the bottom of the container 130 to convey it selectively towards (FIG. 31) and away from (FIG. 32) the nozzle centre 59. When the appendage 202 is in the rest position (FIG. 30) the lower portion of the container 130 is completely free from the appendage 202 and its small plate 203, such that it can be manipulated in the next phases, for example by the capping unit 180.

In a preferred embodiment the machine 1 for producing pots or containers of paint, in particular samples of coloured paints, is configured by filling the paint tanks 22 respectively with white paint and neutral paint which, in varying proportions, can create a continuous range of paints with different degrees of whiteness, which can then expediently be coloured by adding colourant fluid products stored in the colourant tanks 90, in the desired combination according to formulations provided in an internal or external memory of the computerised electronic system of the machine 1.

At least one stack of empty containers 130 and at least one stack of caps 170 are also provided, respectively in the container magazine 16 and the capping station 17. In a rest condition, the humidification device 80 is arranged in such a way that the humidification basin 106 is positioned below the nozzle centre 59.

When a container of particular paint is required, for example through a request entered and displayed beforehand by means of the screen 4, the electronics of the machine 1 commands the handling unit 18 to move towards the container magazine 16, so that the ring 126 of the support member 124 is positioned under a stack of empty containers.

In a storage position, each stack 136 of containers 130 is supported by the peripheral edge of the lower disc 145 of the respective support member 124, as can be seen in FIGS. 20 to 26, on which the collar 131 of the bottom container in the stack 136 bears. The upper disc 146 is positioned in such a way that its curved portion 153 is facing the stack 136. In this configuration, therefore, the peripheral edge of the upper disc 146 does not engage the collar 131 of any container 130.

When it is wished to pick the lower container 130 of a stack 136, the support member 124 of the handling unit 18 is carried underneath that stack 136. The motor 144 of the picking member 141 is then actuated so as to rotate the lower 145 and upper 146 discs by 90° until they reach the position illustrated in FIGS. 22 and 23. In this picking position, the upper disc 146 has rotated in such a way that its peripheral edge has engaged the collar 131 of the penultimate container 130. The lower disc 145 has rotated in such a way that its curved portion 151 is facing the stack 136 of containers. In this picking position, therefore, the peripheral edge of the lower disc 145 no longer engages the collar 131 of the last container 130, which remains free to fall into the ring 126 of the support member 124 positioned underneath the support plate 14. To prevent the bottom container 130 from remaining hanging from the stack 136, the picking member 141 is actuated in rotation by a further few degrees, as can be seen in FIGS. 24 and 25, so that the detachment tooth 152 of the lower disc 145 is inserted between the collar 131 of the last and penultimate containers. A further rotation, as can be seen in FIGS. 26 and 27, causes the containers to separate completely and the last container in the stack 136 to fall into the support member 124. After the last container 130 has been detached and has fallen into the ring 126 of the support member 124, the penultimate container supported by the upper disc 146 becomes the last one in the stack 136. At this point the picking member is returned to its initial storage position, in which the collar 131 of the new last container 130 is let go by the upper disc 146 because it is level with the curved portion 153 and can therefore fall, pushed down by the weight of the whole stack 136 of containers above the latter, on the peripheral edge of the lower disc 145.

The container 130 picked from the container magazine 16 can then be taken under the nozzle centre 59 to be filled by means of delivery of fluid products taken from the paint tanks 22 (22a and/or 22b) and of colourants taken from one or more colourant tanks 90, according to predetermined colorimetric formulas stored in a central or remote memory of the electronic system of the machine 1.

Before delivery of fluid products into the empty container 130 brought under the nozzle centre 59 of the handling unit 18, the humidification device 80 is activated so as to release the nozzle centre 59 from the humidification basin 108, bringing the opening 110 into alignment with the latter. In the event that, based on the requested formulation, use has to be made of one or more colourants not used for some time, the electronic system could first command those colourant conduits to be drained, having first positioned under the nozzle centre 59 the drainage container 106 carried by the humidification device 80.

Preferably, before delivery, the empty container 130 is raised by the lifting member 200 and brought nearer to the lower wall of the nozzle centre 59, preferably until it touches it, so that the mouth of the empty container 130 is sealed by the nozzle centre 59 itself. In this way the complete delivery of all the fluid products provided is ensured, into the container 130. At the end of delivery, the container 130, full of liquids, is brought back to its rest position for subsequent handling, following the lowering of the lifting member 200 and its return to the rest position illustrated in FIG. 30.

Delivery takes place preferably according to a method allowing the most homogeneous distribution of fluids inside the container 130, so as to make the mixing of the fluid products much faster, for example manually after delivery of the full container to the end user or by means of an agitating mixer of a generally known type. Furthermore, the method for delivering fluids makes it possible to reduce, or even completely prevent, the colourants from bathing the walls of the container, thus preventing poor and inconsistent distribution of said colourants into the finished paint.

In producing finished paints according to the invention the colourants are delivered in variable quantities according to the desired shade, but in any case always in substantially smaller quantities than the amounts of the mix of white and neutral paint coming from the tanks 22. According to the optimised method of the present invention, the colourants are delivered at a delivery speed given by the operating speed of the respective colourant pumps 64, in proportion to the total volumetric quantity of colourant required by the specific formulation requested. Moreover, the speed of delivery of the colourants is calibrated so as to end up being distributed as uniformly as possible in the mixture of white and neutral paint delivered into the container 130. The same principle of proportionality can be for delivery of the white paint and the neutral paint.

For example, where 100 mL of finished paint has to be produced, in which the formulation provides for the delivery of 90 mL white paint and 10 mL black colourant, the delivery can preferably, although not exclusively, take place as follows. First a small amount of white paint, for example 10 mL, is delivered, to cover the bottom of the empty container 130 and prevent the black colourant adhering thereto. Next, 70 mL of white paint is delivered, preferably at the highest delivery speed provided by the main delivery pump 50 and at the same time as the 10 mL of black colourant is delivered over the same period. This is favoured by the swept volume of the colourant delivery pump 64, which is less than the swept volume of the main delivery pump 50. In view of the different swept volumes of the two pumps, the delivery speed of black colourant is regulated, if necessary making it lower than the maximum speed that can be achieved with the colourant delivery pump 64. Naturally, where the colourant delivery pump 64 does not manage to “keep up” with the main delivery pump 50 because of the difference in swept volume between the pumps and the amount of colourant requested, the speed of delivery of the white paint will be reduced. Al the end of delivering the 10 mL of black colourant there will also be an amount of white paint equal to 80 mL in the container 130. The last 10 mL of white paint is therefore delivered in such a way as to cover the black colourant and prevent the latter from touching the cap, at the time of sealing the container 130.

To give another, slightly more complex example, so as to clarify the principle of optimised delivery, the production of a paint with a formulation providing for the delivery of 30 mL white paint, 50 mL neutral paint, 15 mL yellow colourant and 5 mL red colourant can be considered. In this case the white and neutral paints are delivered together, the neutral paint pump preferably being commanded to operate at the highest possible speed and the white paint pump at a speed 40% lower, so that they take the same time to complete delivery of the intended quantities of the two paints. The first step is to deliver, for example, 5 mL of neutral paint and, simultaneously, 3 mL of white paint, which together cover the bottom of the empty container 130. Continuing to deliver the two paints in the same proportions and at the same speeds, simultaneous delivery of the yellow and red colourants is then started, at delivery speeds such that the same time is taken to deliver the 15 mL of yellow colourant and the 5 mL of red colourant. The speed of the pump used for the red colourant will therefore be regulated so that it is one-third slower than the speed of the pump used for the yellow colourant. The latter will be regulated so that, considering that the swept volume is different from that of the main delivery pumps 50, delivery of all the yellow colourant (and consequently all the red colourant) takes place within the time used for delivery of almost the whole amount of white and neutral paint except, for example, for the last 5 mL of neutral paint and the last 3 mL of white paint, which are delivered at the end, to cover the colourants and prevent them from coming into contact with the sealing cap 170.

At the end of delivery, the handling unit 18 moves the container 130, now full of paint, away from the nozzle centre 59, which is once again covered by the humidification basin 106 of the humidification device 90. In the event of delivery problems, for example through unexpected opening of the bodywork 2, or through any stoppage of the power supply, or otherwise, the machine 1 discards the container 130 and takes it to the waste zone before resetting itself to the condition of awaiting instructions from a user.

If there are no hitches, the production of paint continues with the transfer of the container 130 to the capping station. In particular, the handling unit positions the support member 124 such that the bottom of the container 130 is aligned above the lifting platform 182. The motor 185 that actuates the rod-crank unit 184 is then activated, and the latter raises the lifting platform 182, which lifts the container 130 up, towards the bottom cap 170 in a stack 171 of caps. Simultaneously, the raising of the lifting platform 182 causes the raising of the shaft 186, the upper wedge-shaped end 187 of which, releasing the notches 195 of the stems 188, allows the jaws 190 to be clamped over the lower portion of the stack 171 of caps. In this way the container 130 can be pressed against the bottom cap 170 of the stack 171, which remains stable. The pressure against the bottom cap 170 causes the container 130 to be sealed. The lowering of the lifting platform causes the container 130 to be dragged away with the cap sealing it, which cap is released from the resilient tabs that hold it on the stack 171. The stack 171 moves down, pushed by the weight on it, so that the penultimate cap now appears in the last position, ready for the capping of a subsequent container.

The capped container 130 is then conveyed to the collection compartment 6 where it is released for delivery outside the machine 1.

Naturally, without prejudice to the principle of the invention, the embodiments and the implementation details can vary greatly from what is described and illustrated while remaining within the scope of the present invention.

1. Dispensing machine for producing paint samples, comprising a main delivery unit for delivering at least two main paints by means of at least two respective main pumps and a colourant delivery unit for delivering a plurality of colourants by means of a corresponding plurality of colourant pumps, the dispensing machine further comprising at least one container magazine and a handling system with a member for supporting a container, which can move at least from the container magazine to a delivery zone common to the main delivery unit and the colourant delivery unit in order to convey an empty container from the container magazine to the delivery zone.

2. Dispensing machine according to claim 1, wherein the main pumps are volumetric pumps each having a first swept volume, the colourant pumps being volumetric pumps each having a second swept volume, less than the first swept volume.

3. Dispensing machine according to claim 1, wherein the main pumps and the colourant pumps deliver fluid products through respective main delivery conduits and colourant delivery conduits, all emerging into a delivery zone positioned within the dispensing machine.

4. Dispensing machine according to claim 1, wherein the main delivery unit comprises main paint tanks positioned below the colourant delivery unit.

5. Dispensing machine according to claim 1, wherein the container magazine comprises supports for truncated-cone-shaped containers stacked inside one another.

6. Dispensing machine according to claim 1, comprising a container extraction device for extracting one empty container at a time from the container magazine and transferring it to the support member of the handling system.

7. Dispensing machine according to claim 1, wherein the colourant delivery unit is supported by a support plate placed substantially at an intermediate height relative to the total height of the dispensing machine.

8. Dispensing machine according to claim 7, wherein the container magazine is supported by the support plate.

9. Dispensing machine according to claim 1 further comprising a magazine for container sealing elements, suitable for sealing the containers of the container magazine, the handling system further being movable from the delivery zone to the sealing element magazine, where the container into which at least one paint has been delivered in the delivery zone is sealed by a sealing element stored in the sealing element magazine.

10. Dispensing machine according to claim 9, wherein a capping unit comprises a system for lifting the container in order to press it against the bottom sealing element of a stack of sealing elements stored in the sealing element magazine.

11. Method for producing paint samples by means of a machine according to claim 1, comprising the phases of delivering at least one of the at least two main paints by means of the at least one respective main pump, and delivering at least one of the plurality of colourants by means of the at least one respective colourant pump.

12. Method for producing paint samples according to claim 11, comprising the phase of picking an empty container from a container magazine, transferring the empty container by means of a handling system to a common delivery zone for the main paints and the colourants, delivering at least one main paint into the empty container, filling it, transferring the full container by means of the handling system to a capping station for capping the container, and transferring the container into a delivery compartment accessible from outside the dispensing machine.
